(19) United States
(12) Patent Application Publication
(10) Pub. No.: US 2023/0181301 A1
(43) Pub. Date: Jun. 15, 2023

(54) ROTATING TOOTHBRUSH

(71) Applicant: Luludent, LLC, Vienna, VA (US)

(72) Inventor: Ahmed SAAD, Vienna, VA (US)

(21) Appl. No.: 18/166,911

(22) Filed: Feb. 9, 2023

Related U.S. Application Data
(60) Provisional application No. 62/327,161, filed on Apr. 25, 2016.

(51) Int. Cl. A61C 17/26; A46B 5/00; A46B 9/04; A46B 13/00; A46B 13/02; A46B 11/06; A46B 15/00; A46D 1/00

(52) U.S. Cl. CPC A61C 17/26; A46B 5/0012; A46B 9/04; A46B 13/001; A46B 13/02; A46B 11/063; A46B 15/0036; A46D 1/0253; A46B 15/0044

(57) ABSTRACT

A toothbrush is provided. The toothbrush may include a brush head having a first brush and a second brush. Each of the first brush and second brush may include bristles extending radially from first ends of the first brush and second brush. The first brush and second brush may rotate in opposite directions along rotational axes parallel to a longitudinal axis of the toothbrush to brush away from the gums of a user and assist with implementing a rolling brushing method.

### FIELD

Embodiments described herein generally relate to a toothbrush. Specifically, embodiments described herein relate to an electrically-powered, rotating toothbrush.

### BACKGROUND

Toothbrushes are essential devices for maintaining oral hygiene. Bristles located at an end of a toothbrush may contact a user's teeth to dislodge debris that accumulates from eating and drinking, for example. By cleaning teeth surfaces and following other recommendations for maintaining oral hygiene, dental issues, such as periodontal disease and gingivitis, may be prevented. It is often recommended to brush teeth twice a day to mitigate or prevent dental issues. By not brushing teeth or by brushing teeth improperly, these and other dental issues may become advanced, requiring intensive treatment at substantial cost and time.

Existing toothbrushes may be mechanically or electrically operated. Although these toothbrushes exist for maintaining oral hygiene, existing toothbrushes may not be effective at mitigating or preventing dental issues. Mechanical toothbrushes may not provide rotation and vibration to apply pressure on a user's teeth and displace lodged debris. In addition, mechanical toothbrushes may not be able to effectively reach certain areas of a user's teeth (e.g., areas between adjacent teeth). Electric toothbrushes may provide additional pressure and the ability to displace lodged debris across a greater surface area. But both mechanical and electric toothbrushes might advance onto a user's gums, which moves debris to the gum interface and contributes to gum recession. Additionally, users may not use proper brushing techniques. By brushing improperly, users may actually trigger or aggravate issues, such as gum recession.

Therefore, a need exists for toothbrushes that facilitate proper brushing.

### BRIEF SUMMARY

Embodiments provide to a toothbrush. The toothbrush may include a handle extending along a longitudinal axis, a first brush extending from the handle and having first bristles, and a second brush extending from the handle and having second bristles. The first bristles may extend radially from and around a circumference of a first end of the first brush and along a length of the first end of the first brush. The second bristles may extend radially from and around a circumference of a first end of the second brush and along a length of the first end of the second brush. The first brush may be configured to rotate in a first direction around a first rotational axis parallel to the longitudinal axis. The second brush may be configured to rotate in a second direction opposite the first direction around a second rotational axis parallel to the longitudinal axis.

In some embodiments, the toothbrush may include a light source arranged on a brush head of the toothbrush and configured to illuminate plaque. In some embodiments, the toothbrush may include a first electric motor coupled to the first brush and configured to rotate the first brush in the first direction, and a second electric motor coupled to the second brush and configured to rotate the second brush in the second direction. In some embodiments, the toothbrush may include a power source disposed in the handle and configured to power the first electric motor and the second electric motor. In some embodiments, the first bristles are curved along its length and includes a first concavity, and the second bristles are curved along its length and includes a second concavity opposite the first concavity. In some embodiments, at least one of the first bristles extends from the first end of the first brush at a 90 degree angle relative to a lateral axis of the first brush, and at least one of the second bristles extends from the first end of the second brush at a 90 degree angle relative to a lateral axis of the second brush. In some embodiments, at least one of the first bristles extends from the first end of the first brush at an oblique angle relative to a lateral axis of the first brush, and at least one of the second bristles extends from the first end of the second brush at an oblique angle relative to a lateral axis of the second brush. In some embodiments, the first bristles are arranged in first rows along the length of the first end of the first brush, and the second bristles are arranged in second rows along the length of the first end of the second brush. In some embodiments, the first rows and the second rows are curved relative to a longitudinal axis of the toothbrush. In some embodiments, the first brush includes a first rotatable rod extending from the handle, and the second brush includes a second rotatable rod extending from the handle. In some embodiments, the toothbrush may include a conduit extending from the handle and configured to distribute water; and a nozzle coupled to the conduit and configured to disperse water from the conduit onto a user's teeth to displace plaque.

Embodiments also provide a toothbrush having a handle extending along a longitudinal axis; and a brush head extending from the handle. The brush head may include a first brush extending from the handle. The first brush may include first bristles extending radially from and around a circumference of a first end of the first brush and along a length of the first end of the first brush. The brush head may also include a second brush extending from the handle. The second brush may include second bristles extending radially from and around a circumference of a first end of the second brush and along a length of the first end of the second brush. The first brush may be configured to rotate in a first direction around a first rotational axis, and the second brush may be configured to rotate the second brush in a second direction opposite the first direction around a second rotational axis that may be parallel to the first rotational axis. The toothbrush may also include a shield extending from the head. The shield may be configured to extend around sides of the head to separate the first bristles and the second bristles from a user's cheek.

In some embodiments, the toothbrush may include a switch configured to simultaneously rotate the first brush in the first direction and the second brush in the second direction. In some embodiments, the shield may include a cap configured to extend across the first end of each of the first brush and the second brush to separate the first bristles and the second bristles from the user's cheek. In some embodiments, a second end of the head may be received in the handle. In some embodiments, the shield may include an intermediate edge. One or more lights may be disposed around the intermediate edge, where the lights may be configured to aid in visualizing plaque on a user's teeth. In some embodiments, the toothbrush may include an indicator light configured to notify a user of a pressure applied to the user's teeth exceeding a predefined threshold pressure.

Embodiments also provide a method of using a toothbrush. The method may include providing a first brush of the toothbrush, where the first brush includes first bristles extending from a first rotatable rod of the first brush and configured to contact upper teeth of a user. The method may also include rotating the first brush in a first rotational direction such that the first bristles move in a direction from a gum of the upper teeth toward a tip of the upper teeth. The method may also include providing a second brush of the toothbrush, where the second brush includes second bristles extending from a second rotatable rod of the first brush and configured to contact lower teeth of the user. The method may also include rotating the second brush in a second rotational direction such that the second bristles move in a direction from a gum of the lower teeth toward a tip of the lower teeth.

In some embodiments, the first bristles may be mounted radially around a circumference of the first rotatable rod, and the second bristles may be mounted radially around a circumference of the second rotatable rod. In some embodiments, the first bristles may extend at an oblique angle relative to the first rotatable rod such that the first bristles may be at an oblique angle relative to the upper teeth when contacting the upper teeth.

### BRIEF DESCRIPTION OF THE DRAWINGS/FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 shows a front view of a toothbrush according to an embodiment.

FIG. 2 shows a side view of the toothbrush of FIG. 1.

FIG. 3 shows an end view of the toothbrush of FIG. 1.

FIG. 4 shows a cross-sectional view of the toothbrush of FIG. 1 along line 4-4 in FIG. 1.

FIG. 5 shows a schematic diagram of components of a toothbrush according to an embodiment.

FIG. 6 shows an end view of a brush according to an embodiment.

FIG. 7 shows an end view of a brush according to an embodiment.

FIG. 8 shows a side view of a brush according to an embodiment.

FIG. 9 shows a side view of a brush according to an embodiment.

FIG. 10 shows a perspective view of a brush according to an embodiment.

FIG. 11 shows a side view of a water flosser according to an embodiment.

FIG. 12 shows a perspective view of a charging station and a toothbrush according to an embodiment.

FIG. 13 shows a view of a toothbrush according to an embodiment in use to brush a user's teeth.

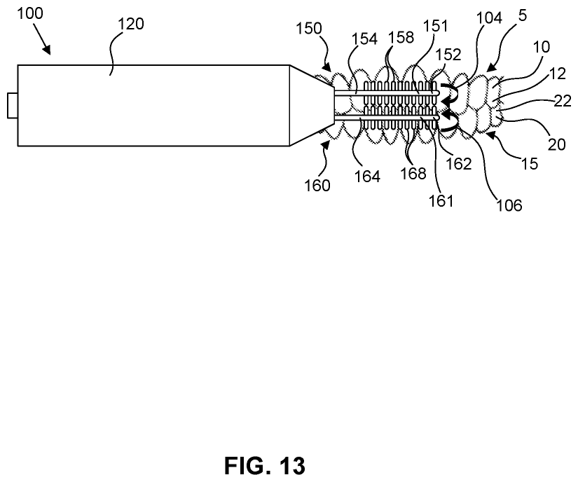

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as may be included within the spirit and scope of the described embodiments as defined by the claims.

Toothbrushes may be electrically operated to provide rotation of bristles. Rotating bristles may facilitate teeth cleaning, as rotation and vibration help to access difficult to reach crevices of a user's teeth and areas between adjacent teeth. Electric toothbrushes may also be easier to use than mechanical toothbrushes. As bristles rotate via a power source in electric toothbrushes, a user does not need to manually create bristle rotation by steadily moving a toothbrush in a circular manner within their mouth.

However, electric toothbrushes may trigger or aggravate dental issues absent additional user compliance. For example, electric toothbrushes may include rotating bristles that rotate outwardly, e.g., away from the teeth's chewing surfaces and toward the gums. This may push dislodged debris to the gum interface and contribute to gum recession. Such toothbrushes do not implement a rolling brushing method.

One technique for effectively brushing teeth is the rolling brushing method which cleans the surfaces of a user's teeth while limiting contact with a user's gums. The rolling brushing method rotates the bristles toward the chewing surfaces of the teeth rather than toward the gum interface. This limits movement of debris toward the gum interface as well as gum recession caused by brushing toward and onto the gums. However, many users may not properly implement the rolling brushing method when using a mechanical toothbrush. Accordingly, an electric toothbrush that facilitates brushing by the rolling brushing method is desirable.

Some embodiments described herein relate to a toothbrush configured to facilitate the rolling brushing method. By providing these features in an electric toothbrush, user adaptation of the rolling brushing method is facilitated such that user compliance with this way of brushing is resolved.

In some embodiments, the toothbrush may include a handle, and a brush head having a first brush and a second brush. The brush head may extend from the handle. The first brush and the second brush may include rotating rods having bristles extending radially from the ends of the rods that are inserted into a user's mouth. The first brush may rotate in a first direction, and the second brush may rotate in a second direction that is opposite the first direction. In this way, when the toothbrush is used to brush teeth, and first bristles contacting upper teeth and the second bristles contacting the lower teeth, the bristles of each of the first brush and second brush rotate toward each other and away from the gum line when the toothbrush is positioned in a user's mouth. In this way, the toothbrush facilitates brushing by the rolling brushing method and avoids gum recession.

The bristles of the brushes may include different materials or geometries and may be positioned on the first brush and second brush in varied arrangements to target certain areas of a user's teeth. For example, bristles toward the ends of a brush head may be larger than bristles at the center of a brush head to facilitate contact with edges of a tooth and areas between adjacent teeth. In addition, bristles may be positioned in rows along the ends of the first brush and the second brush, where the rows may be straight or curved to create a varied tooth contact arrangement. Bristles also may extend from the first brush and the second brush perpendicularly or at oblique angles to further create a varied tooth contact arrangement. Along with facilitating the rolling brushing method, a varied tooth contact arrangement may facilitate advanced teeth cleaning.

Other features of the toothbrush may also support teeth cleaning. As described herein, the toothbrush may include a light source configured to reveal plaque on teeth. By identifying the location of plaque, a user may focus on brushing that area to limit or remove plaque accumulation. Additionally, a shield may be provided on the brush head to separate the bristles of the first and second brushes from a user's cheeks.

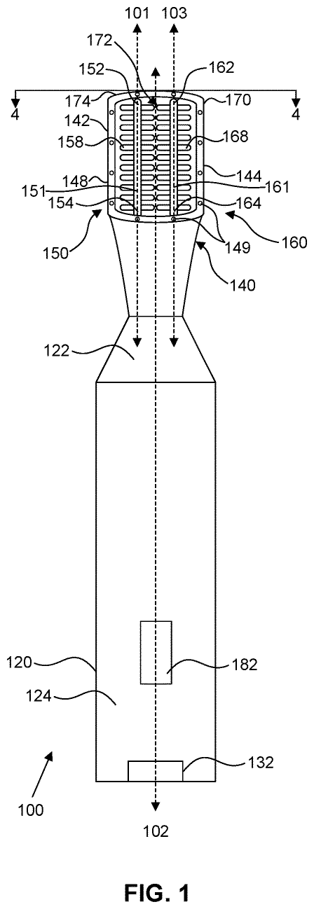

The toothbrush will now be described with reference to the figures. Some embodiments described herein relate to a toothbrush 100, as shown in FIG. 1. Toothbrush 100 may facilitate implementation of the rolling brushing method. Toothbrush 100 may include a handle 120 and a brush head 140. Handle 120 may include an elongated body having a first end 122 opposite a second end 124. First end 122 may be an upper end from which brush head 140 extends. Second end 124 may be a lower end gripped by a user during use of toothbrush 100. In some embodiments, handle 120 may extend along a longitudinal axis 102. In some embodiments, handle 120 does not extend along longitudinal axis 102. For example, handle 120 may be curved along its length. In some embodiments, handle 120 includes a radius of curvature along at least a portion of its length. In some embodiments, handle 120 may have a tubular structure. In some embodiments, a transverse cross sectional area of handle 120 may be circular. In such embodiments, handle 120 may have a generally cylindrical shape. However, handle 120 may have other cross sectional areas such as an oval shaped cross sectional area. Further, handle 120 may have an ergonomic shape to facilitate being held in a hand of a user.

Brush head 140 may extend from first end 122 of handle 120. Brush head 140 may be removably securable to handle 120 or may be permanently attached thereto. Brush head 140 may include one or more brushes configured to contact and clean a user's teeth. In some embodiments, brush head 140 may include a first brush 150 and a second brush 160, as shown for example in FIG. 1. First brush 150 may include a first rod 151 having a first end 152, a second end 154, and first bristles 158 extending from first end 152 of first rod 151. Similarly, second brush 160 may include a second rod 161 having a first end 162, a second end 164, and second bristles 168 extending from first end 162 of second rod 161. Second end 154 and second end 164 extend into handle 120. Each of first brush 150 and second brush 160 may extend along first and second rotational axes 101, 103 that are spaced from and parallel to one another. In some embodiments, the first and second rotational axes 101, 103 may be parallel to a longitudinal axis 102 of handle 120. First brush 150 may be arranged spaced from and parallel to second brush 160. In some embodiments, first and second brushes 150, 160 may be spaced such that the bristles 158, 168 meet end to end, are separated by a space, or overlap along a portion of a length of bristles 158, 168.

First bristles 158 and second bristles 168 may contact a user's teeth to clean the tooth surfaces and dislodge any debris. As shown in FIG. 1, first bristles 158 may extend radially from and around a circumference of a first end 152 of first brush 150 and along a length of first end 152 of first brush 150. Similarly, second bristles 168 may extend radially from and around a circumference of a first end 162 of second brush 160 and along a length of first end 162 of second brush 160.

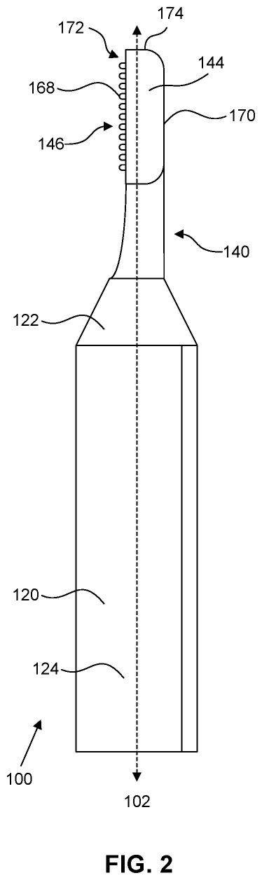

In some embodiments, toothbrush 100 may include a shield 170. With reference to FIGS. 1-2, shield 170 may help to prevent first bristles 158 and second bristles 168 from contacting the inside of the user's cheek. Shield 170 may extend around a first side 142 and a second side 144 of brush head 140. Shield 170 may extend around first side 142 and second side 144 to separate first bristles 158 and second bristles 168 from the user's cheek.

As shown, shield 170 may extend around first bristles 158 and second bristles 168 to form a cavity 172 in which first bristles 158 and second bristles 168 are positioned. Additionally, shield 170 may include an end cap 174 that extends across first end 152 of first brush 150 and first end 162 of second brush 160 to separate first bristles 158 and second bristles 168 from the user's cheek. Accordingly, when toothbrush 100 is positioned in a user's mouth, first bristles 158 and second bristles 168 are only accessible from a front side 146 of brush head 140. When toothbrush 100 is in use, front side 146 faces the user's teeth such that first bristles 158 and second bristles 168 may contact and clean the surfaces of the user's teeth.

In some embodiments, second ends 154, 164 of rods 151, 161 may be connected to end cap 174. Rods 151, 161 may freely rotate with respect to end cap 174, and end cap 174 may stabilize rods 151, 161. In some embodiments, brush head 140 may include a vibration dampening element. Vibration dampening element may be arranged at end cap 174 and at second ends 154, 164 of rods 151, 161.

In addition to facilitating the rolling brushing method, toothbrush 100 may include additional features to support teeth cleaning. In some embodiments, toothbrush 100 may include a light source 149 configured to generate light to illuminate plaque on a user's teeth. The light source 149 may include one or more light emitting diodes (LEDs) or an LED strip, among other light sources. In some embodiments, light source 149 may be arranged on brush head 140. Specifically, in some embodiments, shield 170 may include an intermediate edge 148 facing front side 146 of brush head 140. In some embodiments, light source 149 may be disposed on intermediate edge 148. For example, a plurality of LED lights may be disposed around intermediate edge 148, as shown in FIG. 1. Light from light source 149 may aid in visualizing plaque on a user's teeth. By identifying the location of plaque, a user may focus on brushing that area to limit or remove plaque accumulation. In some embodiments, light may be emitted by light source 149 may be a black light. The light may be a black light. The light may have a wavelength between about 300 nm (nanometers) and about 490 nm, about 320 nm to about 450 nm, or about 350 nm to 400 nm. Light from light source may illuminate plaque such that plaque appears yellow or orange in color. In some embodiments, light source may include one or more LED strips.

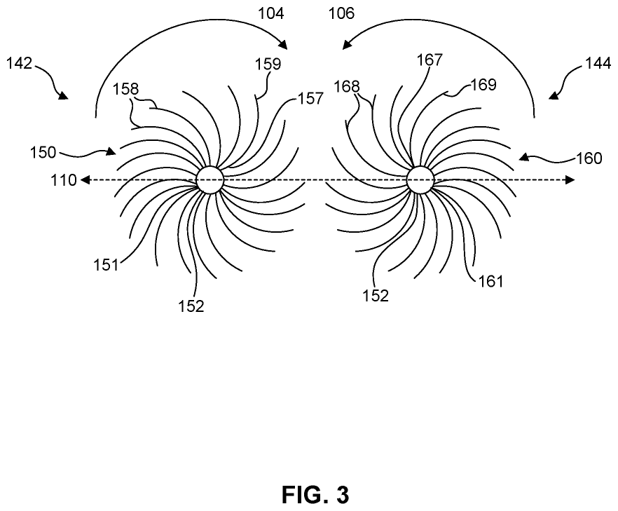

A user may promote proper dental care and teeth cleaning by implementing the rolling brushing method. Toothbrush 100 described herein may assist with implementing the rolling brushing method. As shown in FIG. 3, first brush 150 may rotate in a first direction 104 around a first rotational axis 101 (FIG. 1) parallel to longitudinal axis 102 of handle 120 (FIG. 1). Second brush 160 may rotate in a second direction 106 around a second rotational axis 103 (FIG. 1) parallel to longitudinal axis 102 of handle 120 (FIG. 1). Instead of being the same direction, second direction 106 may be opposite first direction 104. As shown, first brush 150 rotating in first direction 104 may rotate towards second brush 160. Similarly, second brush 160 rotating in second direction 106 may rotate towards first brush 150. Accordingly, first brush 150 and second brush 160 rotate towards each. When applied to a user's teeth, first brush 150 rotating in first direction 104 and second brush 160 rotating in second direction 106 may leverage the rolling brushing method as the bristles move in a direction from gum toward chewing surface of the teeth. This limits movement of debris toward the gum interface as well as gum recession caused by brushing toward and onto the gums.

Improved cleaning may be achieved by curving first bristles 158 and/or second bristles 168. As shown in FIG. 3, first bristles 158 may include a first end 157 that is connected to first rod 151 and a second end 159 that is a free end (unattached). Similarly, second bristles 168 may include a first end 167 and a second end 169. First end 167 may be connected to first rod 151. Second end 169 may be a free end (unattached).

In some embodiments, at least one first bristle 158 may be curved along its length from first end 157 to second end 159. In this way, first bristles 158 may include a radius of curvature. In some embodiments, first bristles 158 are concave upward towards first side 142 of brush head 140 (FIG. 1). In some embodiments, at least one first bristle 158 includes a constant radius of curvature along its length from first end 157 to second end 159. Similarly, in some embodiments, at least one second bristle 168 may be curved along its length from first end 167 to second end 169. In this way, second bristles 168 include a radius of curvature. In some embodiments, at least one second bristle 168 is concave upward towards second side 144 of brush head 140 (FIG. 1). In some embodiments, second bristles 168 include a constant radius of curvature along its length from first end 167 to second end 169. In some embodiments, all first bristles 158 may be curved along their length, and similarly all second bristles 168 may be curved along their length.

During brushing, the curvature of first bristles 158 and/or second bristles 168 may change from the contact pressure. Therefore, the curvature described herein is in reference to natural states of first bristles 158 and second bristles 168, e.g., when no pressure is applied. The natural curvature of first bristles 158 and/or second bristles 168 may reduce contact pressure applied to a user's teeth. A less abrasive contact may be desirable to accommodate tooth damage and/or gum sensitivity. In some embodiments, a portion of first bristles 158 and/or second bristles 168 may be curved to further vary the tooth contact arrangement.

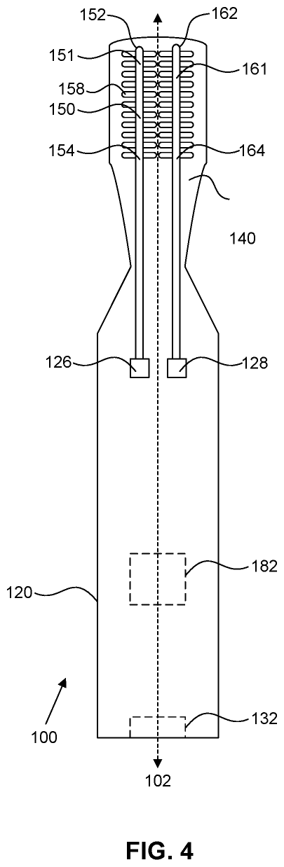

Toothbrush 100 may include one or more motors configured to cause rods 151, 161 (FIG. 1) of brushes 150, 160 to rotate about first and second rotational axes 101, 103 (FIG. 1). Rotation of brushes 150, 160 may assist with implementing the rolling brushing method. With reference to FIGS. 3-4 in some embodiments, second end 154 of first brush 150 may be disposed within handle 120 and may be connected to a first motor 126 such that first motor 126 drives first brush 150. Second end 164 of second brush 160 may be disposed in handle 120 and may be connected to second motor 128 such that second motor 128 drives second brush 160. First motor 126 may drive first brush 150 in first direction 104 and second motor 128 may drive second brush 160 in second direction 106 opposite first direction 104. For example, first brush 150 may rotate in a clockwise direction and second brush 160 may rotate in a counterclockwise direction, such that brushes 150, 160 rotate toward one another. First brush 150 may be driven by first motor 126 independently of second brush 160.

As shown in FIG. 4, handle 120 may include a switch 182 configured to be operated to provide electrical energy from power source 134 to one or more motors 126, 128. Powering toothbrush 100 facilitates rotation of first brush 150 and second brush 160 to create a brushing action. In this way, first bristles 158 and second bristles 168 may be rotated in a user's mouth to clean the user's teeth.

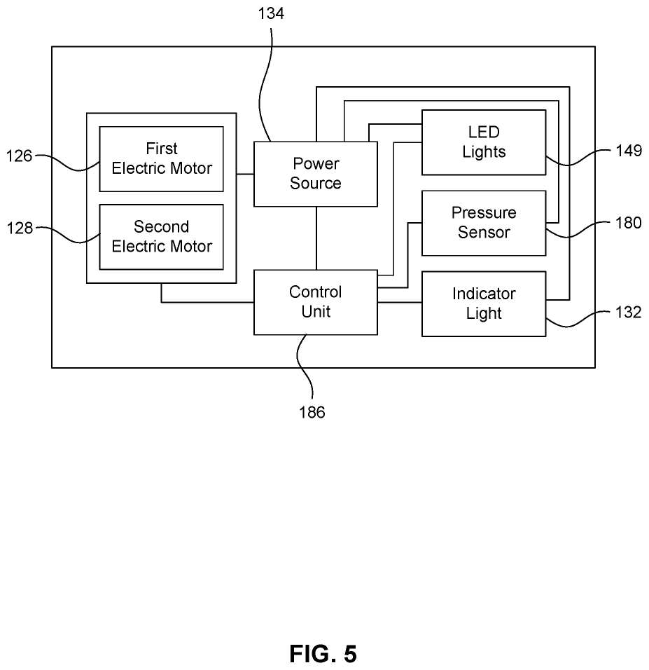

In some embodiments, handle 120 may include an indicator light 132 configured to indicate that toothbrush 100 is powered on. Indicator light 132 and other components of toothbrush 100 may be controlled and powered. With reference to FIGS. 4-5, first brush 150 may be operatively connected to first motor 126. First rod 151 of first brush 150 may extend from first motor 126. Similarly, second brush 160 may be operatively connected to second motor 128. Second rod 161 of second brush 160 may extend from second motor 128. When actuated, first motor 126 may rotationally drive first brush 150 via first rod 151, and second motor 128 may rotationally drive second brush 160 via second rod 161. First motor 126 may rotate first brush 150 in first direction 104 and second motor 128 may rotate second brush 160 in second direction 106. In this way, first bristles 158 mounted to first rod 151 and second bristles 168 mounted to second rod 161 rotate in first direction 104 and second direction 106, respectively. First brush 150 and second brush 160 may rotate relative to shield 170.

In some embodiments, first motor 126 and second motor 128 may be electric motors coupled to power source 134. In some embodiments, power source 134 may include one or more disposable batteries, or may include a rechargeable battery. In some embodiments, first motor 126, second motor 128, and power source 134 may be enclosed within handle 120. Switch 182 may actuate power source 134 as well as first motor 126 and second motor 128. Accordingly, by actuating power source 134, switch 182 may simultaneously rotate first brush 150 in first direction 104 and second brush 160 in second direction 106 (FIG. 3). Power source 134 may be coupled to indicator light 132 and light source 149 as well. Switch 182 coupled to power source 134 may cause actuation of indicator light 132 and light source 149. In some embodiments, switch 182 is actuated by depressing switch 182 (e.g., pushing or applying a force to switch 182). By depressing switch 182, power may be supplied to first motor 126, second motor 128, indicator light 132, and/or light source 149.

In some embodiments, actuation of first motor 126, second motor 128, indicator light 132, and/or light source 149 may be controlled. As shown in FIG. 5, a control unit 186 may be configured to control operation of components of toothbrush 100. With reference to FIGS. 4-5, in some embodiments, control unit 186 may be disposed in handle 120. Control unit 186 may be operatively connected to components of toothbrush 100, including switch 182, power source 134, first motor 126, second motor 128, indicator light 132, and light source 149. In some embodiments, switch 182 may actuate power source 134 via control unit 186.

Control unit 186 may be a computer system embedded within toothbrush 100. In some embodiments, control unit 186 may include a microprocessor, a memory (e.g., random access memory and/or a removable storage unit), a data transmitter to communicate with external devices (e.g., a handheld device, such as a smartphone), a display device that may include inputs and graphics, and/or a timer. Communication may utilize electronic, electromagnetic, or optical signals via wired or wireless communication channels. In some embodiments, the memory may store programmed actions.

In some embodiments, control unit 186 may selectively control distribution of electrical energy from power source to each of first motor 126, second motor 128, indicator light 132, and light source 149. In some embodiments, control unit 186 may store operational routines of programmable logic (e.g., control logic) stored locally or remotely for operating toothbrush 100 and its components as described herein. Logic of control unit 186 may be locally stored in a memory or retrieved from a remote location or software product and loaded into control unit 186. Operational routines may be energized based on actuation of switch 182. For example, actuating switch 182 once may run a first routine. Actuating switch 182 a second time may run a second routine alternatively or in addition to the first routine. In some embodiments, in a first routine, control unit 186 may cause motors 126, 128 to be activated for a programmed time, such as 120 seconds, 90 seconds, or 60 seconds, among other periods of time. In some embodiments, after the timer reaches 120 seconds, power source 134 is no longer deactivated or disconnected from the motors 126, 128 and other components. In some embodiments, after the timer reaches two minutes, actuation of power source 134 is pulsed to indicate to a user that they have completed a brushing action. In some embodiments, a user may be required to trigger switch 182 to cease actuation of power source 134. In another routine, light source 149 may be energized as first brush 150 and second brush 160 are rotated. In some embodiments, light source 149 are not energized in a first instance of powering toothbrush 100. Accordingly, a routine must be run to energize light source 149.

In some embodiments, toothbrush 100 may include a pressure sensor 180 configured detect a pressure applied to brush head 140. Pressure sensor 180 may be arranged in brush head 140 or in a handle 120 of toothbrush 100. Control unit 186 may store a threshold pressure and may be configured to activate an indicator when the pressure detected by the pressure sensor 180 exceeds the threshold pressure. In some embodiments, pressure sensor 180 resists applied force such that compression that exceeds the threshold pressure provides an electrical output (e.g., pressure sensor 180 may be a strain gage). Indicator may include an indicator light, e.g., indicator light 132, or may include activation of a vibration mechanism, or may include an audible tone, among other indicators. This may help to alert the user that he or she is brushing with too much force or pressure. Brushing with too much force or pressure applied to the teeth may result in gum erosion among other dental issues.

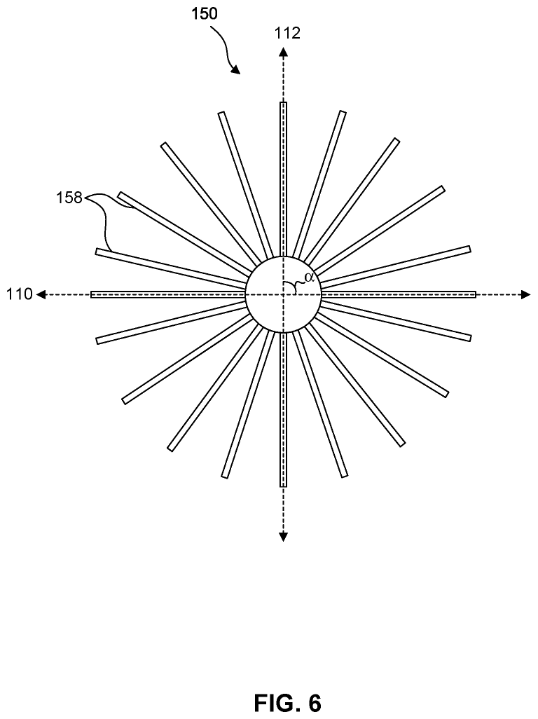

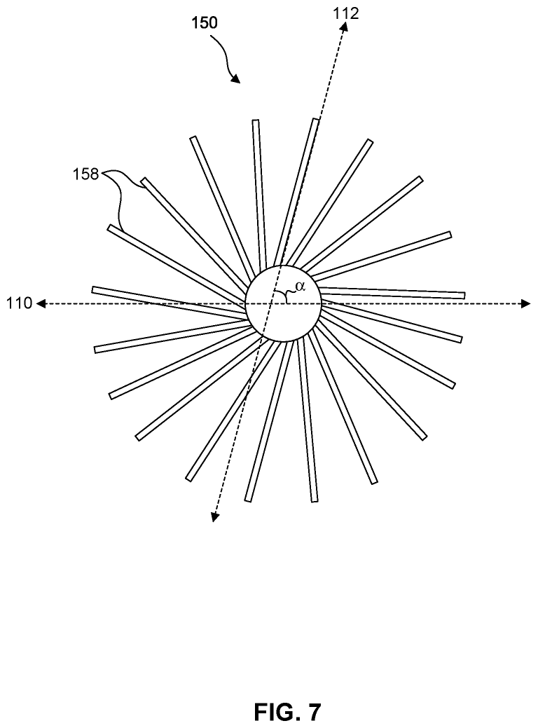

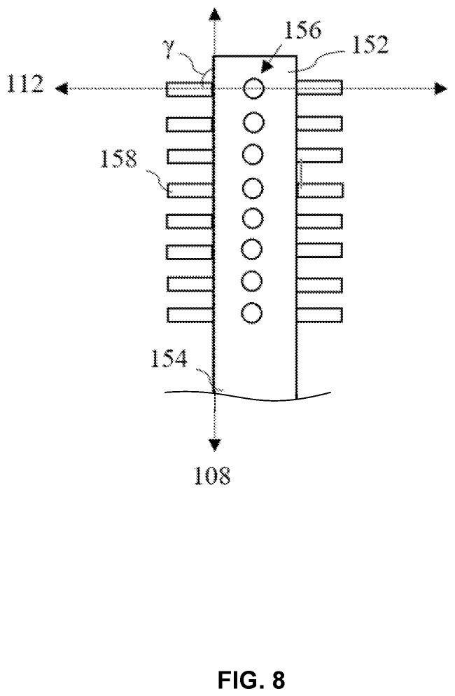

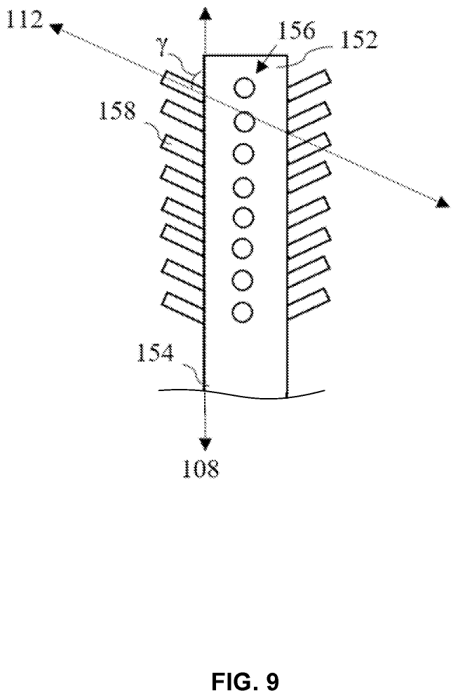

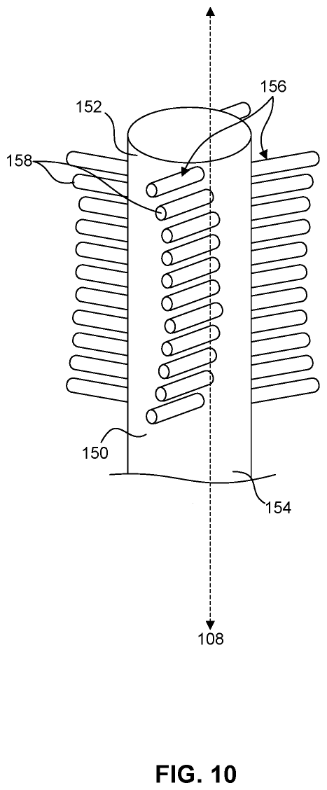

A varied tooth contact arrangement may advance teeth cleaning in addition to implementing the rolling brushing method, as shown in FIGS. 6-10. In addition to or alternative to first bristles 158 and second bristles 168 being curved, as discussed above with reference to FIG. 3, first bristles 158 may extend from first rod 151 at different angles (FIGS. 6-7), along a straight line (FIGS. 8-9), and/or curved line (FIG. 10). With reference to FIGS. 8-10, first bristles 158 may be arranged in one or more first rows 166 along the length of first end 152 of first brush 150. Second bristles 168 may include the same or different arrangement as first bristles 158.

Various first bristles 158 and/or second bristles 168 arrangements will now be described with reference to FIGS. 6-10. It should be understood that description relating to first brush 150 and its components is applicable to second brush 160 and its corresponding components.

Instead of being curved, at least one first bristle 158 and/or second bristle 168 may be generally linear in the natural state. Linear first bristles 158 and/or second bristles 168 may be appropriate to target teeth where there is little damage and/or if a user has healthy gums. As shown in FIG. 6, first brush 150 may include a brush lateral axis 110 extending laterally across first brush 150. Brush lateral axis 110 is perpendicular to longitudinal axis 102 of toothbrush 100 (FIG. 1). Each first bristle 158 may extend along a bristle axis 112 that is arranged at an angle α with respect to brush lateral axis 110. In some embodiments, angle α may be approximately 90 degrees. In some embodiments, as shown in FIG. 7, angle α may be an oblique angle. In some embodiments, angle α may be between approximately 20 degrees and approximately 90 degrees, such as between approximately 40 degrees and approximately 70 degrees, such as approximately 60 degrees.

In some embodiments, at least one first bristle 158 and second bristle 168 may be perpendicular to longitudinal axis 102 of toothbrush 100, shown in FIG. 1. Alternatively, at least one first bristle 158 and second bristle 168 may be angled relative to longitudinal axis 102. As discussed above, first bristles 158 may be arranged in first rows 156 along the length of first end 152 of first brush 150. First brush 150 may include a plurality of first rows 156 of first bristles 158 along the length of first end 152 of first brush 150, as shown in FIG. 8. In some embodiments, first row 156 may extend along a longitudinal axis 108, which may be parallel to longitudinal axis 102. Longitudinal axis 108 and bristle axis 112 form an angle γ. Therefore, first bristles 158 may extend along bristle axis 112 at angle γ from longitudinal axis 108. In some embodiments, angle γ may be approximately 90 degrees. Accordingly, first bristles 158 may extend from first end 152 of first brush 150 at a 90 degree angle γ relative to longitudinal axis 108. In some embodiments, as shown in FIG. 9, angle γ may be an oblique angle. Accordingly, first bristles 158 may extend from first end 152 of first brush 150 at an oblique angle γ relative to longitudinal axis 108. In some embodiments, angle γ may be between approximately 20 degrees and approximately 90 degrees, such as between approximately 40 degrees and approximately 70 degrees, such as approximately 60 degrees.

In some embodiments, first rows 156 do not extend along a longitudinal axis parallel to longitudinal axis 102. As shown in FIG. 10, first rows 156 may be curved along a length of first brush 150. Alternatively, first rows 156 may extend helically around first rod 151, or may be arranged at an angle to longitudinal axis 108. In this way, first rows 156 may further vary the tooth contact arrangement.

Bristles may be selected based on material, such as to provide a desired physical property, such as stiffness. In some embodiments, at least one first bristle 158 and/or second bristle 168 may include a synthetic material, such as nylon, among other materials. In some embodiments, at least one bristle may be selected to have a certain length or thickness. For example, at least one first bristle 158 toward first end 152 and second end 154 of first brush 150 may be larger (e.g., longer and/or thicker) than first bristles 158 between first end 152 and second end 154. Similarly, at least one second bristle 168 toward first end 162 and second end 164 of second brush 160 may be larger (e.g., longer and/or thicker) than first bristles 158 between first end 162 and second end 164. This arrangement may facilitate contact with edges of a tooth and areas between adjacent teeth. Different quantities of first bristles 158 and/or second bristles 168 may also be included. A greater quantity of bristles grouped together may allow the bristles to move as a composite. Bristles may support and reinforce adjacent bristles. In this way, bristles maintain contact with the teeth and do not splay.

Each brush may include a combination of the bristle arrangements described herein. For example, a brush may include a combination of two or more of linear bristles, curved bristles, bristles at different angles with respect to the longitudinal or lateral axes, bristles of different dimensions, and bristles of different materials.

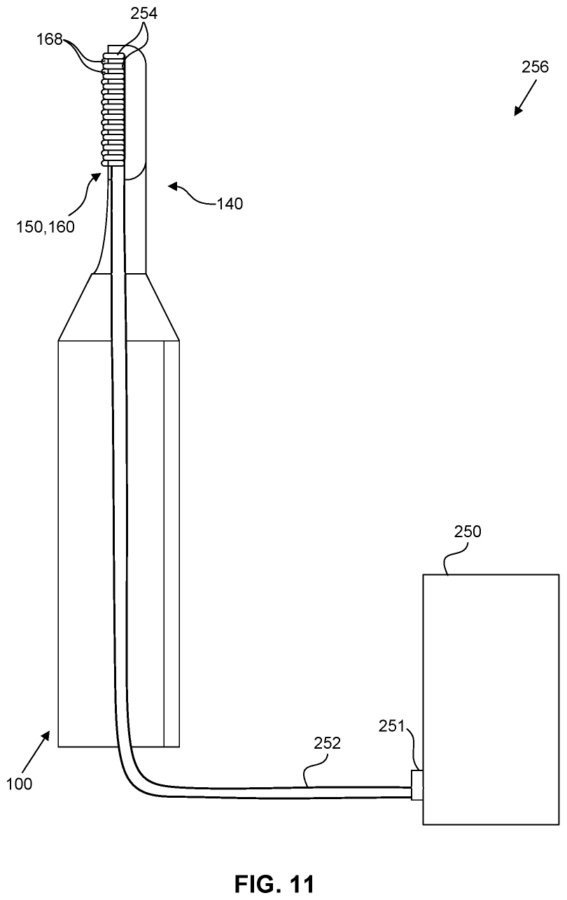

Along with facilitating the rolling brushing method and optimizing the tooth contact arrangement, the toothbrush described herein may assist with flossing to further enhance teeth cleaning. In some embodiments as shown in FIG. 11, toothbrush 100 may include a water flosser 256. Toothbrush 100 may include one or more nozzles 254 for dispensing a pressurized stream of water (e.g., a water jet). The pressurized stream of water may be used to dislodge debris between the user's teeth to assist with flossing. Nozzles 254 may be arranged at brush head 140. In some embodiments, nozzle 254 may be arranged adjacent to brushes 150, 160, such as between brushes 150, 160. Toothbrush 100 may include a conduit 252 connecting nozzle 254 to a source of water 250 (e.g., a faucet or a receptacle for water). A pump 251 may be provided to provide a pressurized flow of water. Control unit 186 (FIG. 5) of toothbrush 100 may be in operable connection with pump 251 and may control the flow rate of the water. In some embodiments, water flosser 256 may provide a pulsing pressurized stream of water. Operational routines of control unit 186 may control operation of water flosser 256 and its components. Accordingly, as switch 182 (FIG. 4) actuates operations of toothbrush 100, switch 182 (FIG. 4) may also actuate water flosser 256. Operational routines to control water flosser 256 may include on, off, and various flow rates (e.g., high speed or low speed). In some embodiments, water flosser 256 is detachable from toothbrush 100.

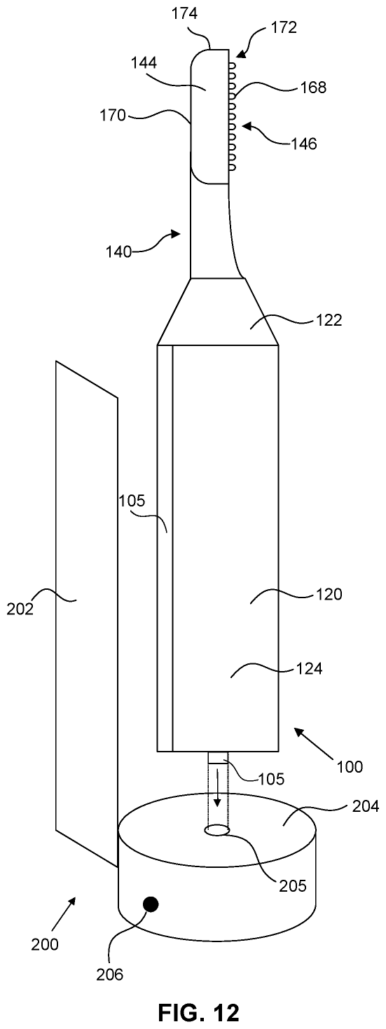

When not in use, toothbrush 100 may be stored by a toothbrush holding assembly 200, shown in FIG. 12. Holding assembly 200 may retain toothbrush 100 to prevent loss or contamination of toothbrush 100 from contact with surfaces. Holding assembly 200 may include structures to support first end 122 and second end 124, for example. In this way, holder 202 may extend around one or more sides of toothbrush 100 to support toothbrush 100. In some embodiments, holding assembly 200 may include a holder 202 and a base 204 to receive second end 124 of toothbrush 100. Base 204 is configured to support a toothbrush 100 in an upright orientation. In some embodiments, base 204 may include a disk-shape. Holder 202 may include an elongated body and may extend from base 204 along a side of base 204. Holder 202 may be configured to extend along a handle of toothbrush 100 when toothbrush 100 is supported on base 204. In some embodiments, power source 134 (FIG. 5) may be configured to be charged by holder 202.

In some embodiments, holder 202 and base 204 may receive toothbrush 100 to charge power source 134 of toothbrush 100. In some embodiments, toothbrush 100 may include a first fastener 105 configured to engage with a second fastener 205 of base 204. In some embodiments, first fastener 105 may include one or more magnets. In some embodiments, first fastener 105 may be arranged on second end 124 of toothbrush 100. In some embodiments, first fastener 105 may include a protrusion that is received by second fastener 205 of base 204. In some embodiments, second fastener 205 includes one or more magnets. In some embodiments, one of first fastener 105 and second fastener 205 may be magnetic, and the other of first fastener 105 and second fastener 205 may be ferromagnetic.

In some embodiments, first fastener 105 may be configured to engage with holder 202. First fastener 105 may include a magnetic strip and may extend along a side of toothbrush 100. In some embodiments, holder 202 may be magnetic such that toothbrush 100 may magnetically couple to holder 202 via first fastener 105.

In some embodiments, holding assembly 200 includes a charging member 206 for providing electrical energy to a power source of toothbrush 100. Charging member 206 may include an inductive coil for wireless charging. Charging member 206 may alternatively include a connector configured to engage with toothbrush 100 to supply electrical energy to recharge power source. Holding assembly 200 may receive electrical energy from an electrical outlet, among other sources of electricity.

In some embodiments, holding assembly 200 may be configured to support toothbrush 100 in an upside-down manner. For example, holder 202 may support toothbrush 100 in an upside-down manner. First fastener 105 may include a magnetic strip and may extend along a side of toothbrush 100 such that toothbrush 100 may magnetically couple to holder 202 via first fastener 105 while upside-down. In this way, brush head 140 may be arranged within a cup of mouthwash, cleansing solution, or the like to maintain cleanliness of brush head 140. First bristles 158 and second bristles 168 may be cleaned while brush head 140 is soaked or dipped in the cup. The cup may be placed on holding assembly 200, such as on base 204, to receive brush head 140 when toothbrush 100 is supported by holder 202 in an upside-down manner.

Toothbrush 100 used for brushing a user's teeth with the rolling brushing method is shown for example in FIG. 12. As discussed, first brush 150 including first bristles 158 may be provided. First brush 150 may contact upper teeth 10 of a user and rotate in first direction 104 from a gum 5 of upper teeth 10 toward a tip 12 of upper teeth 10 (e.g., a chewing surface). Second brush 160 may contact lower teeth 20 of a user and rotate in second direction 106 from a gum 15 of lower teeth 20 toward a tip 22 of lower teeth 20 (e.g., a chewing surface). In some embodiments, first bristles 158 extend at an angle relative to first rod 151 such that first bristles 158 are at an angle relative to upper teeth 10 when contacting upper teeth 10. Similarly, in some embodiments, second bristles 168 extend at an angle relative to first rod 151 such that first bristles 158 are at an angle relative to lower teeth 20 when contacting lower teeth 20.

When user brushes the rear surface of teeth 10, 20, brushes 150, 160 will similarly rotate away from gums 5, 15 and toward the tips 12, 22 of teeth 10, 20 without the need to change operation of toothbrush 100. Thus, toothbrush 100 facilitates performance of the rolling brushing method to properly clean the user's teeth.

It is to be appreciated that the Detailed Description section, and not the Summary and Abstract sections, is intended to be used to interpret the claims. The Summary and Abstract sections may set forth one or more but not all exemplary embodiments of the present invention(s) as contemplated by the inventors, and thus, are not intended to limit the present invention(s) and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention(s) that others may, by applying knowledge within the skill of the art, readily modify and/or adapt for various applications such specific embodiments, without undue experimentation, and without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance herein.

What is claimed is:

1. A toothbrush, comprising:
a handle extending along a longitudinal axis;
a first brush extending from the handle and comprising first bristles, the first bristles extending radially from and around a circumference of a first end of the first brush and along a length of the first end of the first brush; and
a second brush extending from the handle and comprising second bristles, the second bristles extending radially from and around a circumference of a first end of the second brush and along a length of the first end of the second brush,
wherein the first brush is configured to rotate in a first direction around a first rotational axis parallel to the longitudinal axis, and
wherein the second brush is configured to rotate in a second direction opposite the first direction around a second rotational axis parallel to the longitudinal axis.

2. The toothbrush of claim 1, further comprising:
a light source arranged on a brush head of the toothbrush and configured to illuminate plaque.

3. The toothbrush of claim 1, further comprising:
a first electric motor coupled to the first brush and configured to rotate the first brush in the first direction, and
a second electric motor coupled to the second brush and configured to rotate the second brush in the second direction.

4. The toothbrush of claim 2, further comprising:
a power source disposed in the handle and configured to power the first electric motor and the second electric motor.

5. The toothbrush of claim 1, wherein the first bristles are curved along its length and comprises a first concavity, and
wherein the second bristles are curved along its length and comprises a second concavity opposite the first concavity.

6. The toothbrush of claim 1, wherein at least one of the first bristles extends from the first end of the first brush at a 90 degree angle relative to a lateral axis of the first brush, and
wherein at least one of the second bristles extends from the first end of the second brush at a 90 degree angle relative to a lateral axis of the second brush.

7. The toothbrush of claim 1, wherein at least one of the first bristles extends from the first end of the first brush at an oblique angle relative to a lateral axis of the first brush, and
wherein at least one of the second bristles extends from the first end of the second brush at an oblique angle relative to a lateral axis of the second brush.

8. The toothbrush of claim 1, wherein the first bristles are arranged in first rows along the length of the first end of the first brush, and
wherein the second bristles are arranged in second rows along the length of the first end of the second brush.

9. The toothbrush of claim 8, wherein the first rows and the second rows are curved relative to a longitudinal axis of the toothbrush.

10. The toothbrush of claim 1, wherein the first brush comprises a first rotatable rod extending from the handle, and
wherein the second brush comprises a second rotatable rod extending from the handle.

11. The toothbrush of claim 1, further comprising:
a conduit extending from the handle and configured to distribute water; and
a nozzle coupled to the conduit and configured to disperse water from the conduit onto a user's teeth to displace plaque.

12. A toothbrush, comprising:
a handle extending along a longitudinal axis;
a brush head extending from the handle, the brush head comprising:
a first brush extending from the handle, wherein the first brush comprises first bristles extending radially from and around a circumference of a first end of the first brush and along a length of the first end of the first brush, and
a second brush extending from the handle, the second brush comprising second bristles extending radially from and around a circumference of a first end of the second brush and along a length of the first end of the second brush,
wherein the first brush is configured to rotate in a first direction around a first rotational axis, and
wherein the second brush is configured to rotate the second brush in a second direction opposite the first direction around a second rotational axis that is parallel to the first rotational axis; and
a shield extending from the head, wherein the shield is configured to extend around sides of the head to separate the first bristles and the second bristles from a user's cheek.

13. The toothbrush of claim 12, further comprising:
a switch configured to simultaneously rotate the first brush in the first direction and the second brush in the second direction.

14. The toothbrush of claim 12, wherein the shield comprises a cap configured to extend across the first end of each of the first brush and the second brush to separate the first bristles and the second bristles from the user's cheek.

15. The toothbrush of claim 12, wherein a second end of the head is received in the handle.

16. The toothbrush of claim 12, wherein the shield comprises an intermediate edge, and
wherein one or more lights are disposed around the intermediate edge, the lights configured to aid in visualizing plaque on a user's teeth.

17. The toothbrush of claim 12, further comprising:
an indicator light configured to notify a user of a pressure applied to the user's teeth exceeding a predefined threshold pressure.

18. A method of using a toothbrush, the method comprising:
providing a first brush of the toothbrush, the first brush comprising first bristles extending from a first rotatable rod of the first brush and configured to contact upper teeth of a user;
rotating the first brush in a first rotational direction such that the first bristles move in a direction from a gum of the upper teeth toward a tip of the upper teeth;
providing a second brush of the toothbrush, the second brush comprising second bristles extending from a second rotatable rod of the first brush and configured to contact lower teeth of the user;
rotating the second brush in a second rotational direction such that the second bristles move in a direction from a gum of the lower teeth toward a tip of the lower teeth.

19. The method of claim 18, wherein the first bristles are mounted radially around a circumference of the first rotatable rod, and
wherein the second bristles are mounted radially around a circumference of the second rotatable rod.

20. The method of claim 18, wherein the first bristles extend at an oblique angle relative to the first rotatable rod such that the first bristles are at an oblique angle relative to the upper teeth when contacting the upper teeth.
